(19) United States
(12) Patent Application Publication
(10) Pub. No.: US 2025/0390534 A1
(43) Pub. Date: Dec. 25, 2025

(54) METHODS AND SYSTEMS FOR MAPPING DATA USING SEMANTIC MAPPING BY A DATA MAPPING SYSTEM

(71) Applicant: KONINKLIJKE PHILIPS N.V., EINDHOVEN (NL)

(72) Inventors: Man Ching Cheung, Cambridge, MA (US); Jon Kamerman, Andover, MA (US)

(21) Appl. No.: 19/239,089

(22) Filed: Jun. 16, 2025

Related U.S. Application Data
(60) Provisional application No. 63/663,203, filed on Jun. 24, 2024.

(51) Int. Cl. G06F 16/84; G06F 3/0482

(52) U.S. Cl. CPC G06F 16/86; G06F 3/0482

(57) ABSTRACT

A method for mapping data by a data mapping system, comprising: generating, from a database of datapoints, a list of one or more datapoints to be mapped, wherein the list of one or more datapoints is saved in a datapoints results table; providing the list of one or more datapoints to be mapped; receiving a mapping input comprising a new mapping of one or more of the datapoints, the mapping comprising a new label for a datapoint; automatically mapping, based on the received mapping input, one or more additional datapoints from the database of datapoints; and automatically saving the new mapping of one or more of the datapoints and the mapped one or more additional datapoints from the database of datapoints in a results database.

### CROSS-REFERENCE TO RELATED APPLICATIONS

This patent application claims the priority benefit under 35 U.S.C. § 119 (e) of U.S. Provisional Application No. 63/663,203, filed on Jun. 24, 2024, the contents of which are herein incorporated by reference.

### FIELD OF THE DISCLOSURE

The present disclosure is directed generally to methods and systems for mapping data using semantic and contextual mapping by a data mapping system.

### BACKGROUND

Data labeling and mapping is a critical component of data analytics. Identifying or extracting patterns or correlations from the data within a dataset can be difficult if that data is unorganized or otherwise unclear. For example, a basic problem in deploying simple data models for analytics is the extreme localization of data use over the customer space. In many instances, users require flexibility to ingest and map existing data, as well as new data as it is received. The time domain can therefore span decades. While coding schemas exist, users still need a way to annotate data by meaning, both contextual and semantic, that is relevant and specific to the user's intended analysis of the data.

For example, an integrated delivery network (IDN)—sometimes referred to as a health system—may comprise many hospitals and clinics. A user or system may desire to group these locations into units that are more useful for administrative and operational use cases, among other analytics. These needs extend to many different fields including grouping by departments, by technicians, by physicians, by finding codes, by measurements, and many more. When performing data extraction and transformation, the traditional approach is to manually build out the data storage and custom mapping code to store this information. However, this dependency on a programmer, or a database engineer, or a data expert, to execute the mapping prevents scalability.

More generally, this data mapping problem extends beyond the healthcare domain into any domain that relies heavily on data while the domain knowledge (comprising semantic, contextual, and vernacular meanings) resides with non-technical users.

### SUMMARY OF THE DISCLOSURE

There is thus a continued unmet need for methods and systems that enable efficient and scalable data labeling and mapping for large datasets, including by non-technical experts.

Various embodiments and implementations are directed to a method and system for mapping data using semantic mapping by a data mapping system. The data mapping system generates a list of datapoints to be mapped from a database of datapoints, and receives a mapping input comprising a new mapping of one or more of the datapoints in the list, the mapping comprising a new label for a datapoint. The system then maps, based on the received mapping input, one or more additional datapoints from the database of datapoints. The newly mapped datapoints are then saved in a results database, wherein each mapped datapoint is associated with a reference to the corresponding unmapped datapoint in the database of datapoints.

According to an aspect, a method for mapping data using semantic mapping by a data mapping system is provided. The method includes: (i) generating, by the data mapping system from a database of datapoints, a list of one or more datapoints to be mapped, wherein the list of one or more datapoints is saved in a datapoints results table, and wherein the datapoints to be mapped are not yet mapped in the database of datapoints; (ii) providing the list of one or more datapoints to be mapped; (iii) receiving a mapping input comprising a new mapping of one or more of the datapoints, the mapping comprising a new label for a datapoint; (iv) automatically mapping, by the data mapping system based on the received mapping input, one or more additional datapoints from the database of datapoints; and (v) automatically saving the new mapping of one or more of the datapoints and the mapped one or more additional datapoints from the database of datapoints in a results database, wherein each mapped datapoint in the results database is associated with a reference to the corresponding unmapped datapoint in the database of datapoints.

According to an embodiment, at least some of the mapping input is generated by a trained data mapping machine learning algorithm.

According to an embodiment, the list of one or more datapoints to be mapped is provided to a user via a user interface of the data mapping system, and the mapping input is received from the user via the user interface.

According to an embodiment, the list of one or more datapoints to be mapped each comprises a type of mapping and a data value.

According to an embodiment, the list of one or more datapoints to be mapped is generated by a fetch module of the data mapping system.

According to an embodiment, each datapoint in the list of one or more datapoints to be mapped is representative of a plurality of datapoints in the database of datapoints.

According to an embodiment, multiple datapoints to be mapped can be mapped to the same new label, and each datapoint to be mapped can be mapped to multiple, different new labels.

According to an embodiment, the method further includes updating the mapping, comprising the steps of: automatically mapping, by the data mapping system based on the mapping input received from the user, one or more new datapoints from the database of datapoints; and automatically saving the mapping of the one or more new datapoints from the database of datapoints in a results database. According to an embodiment, the mapping is updated in response to a command to update received from the user via the user interface.

According to an embodiment, the method further includes performing, using the mapped datapoints in the results database, analytics. The analytics can include, for example, operations on the datapoints, including basic control flow (e.g., IF-THEN), pattern match, Boolean logic operations, grouping, and calculations (for example, but not limited to, addition, subtraction, multiplication, division, max/min, and matrix operations, among others).

According to an embodiment, original datapoints can be mapped to new labeled datapoints or to new calculated datapoints.

According to an embodiment, mapping datapoints to a new label is a form of calculation.

According to an embodiment, combinations of a plurality of original datapoints can be mapped to a new result datapoint, by performing mathematical, Boolean, and text matching operations on multiple input datapoints.

According to another aspect is a system for mapping. The system includes a database of datapoints; a populate module configured to generate, from the database of datapoints, a list of one or more datapoints to be mapped, wherein the list of one or more datapoints is saved in a datapoints results table, and wherein the datapoints to be mapped are not yet mapped in the database of datapoints; a mapper module configured to: (i) receive a mapping input comprising a new mapping of one or more of the datapoints, the mapping comprising a new label for a datapoint; and (ii) automatically map, based on the received mapping input, one or more additional datapoints from the database of datapoints; and a store module configured to automatically save the new mapping of one or more of the datapoints and the mapped one or more additional datapoints from the database of datapoints in a results database, wherein each mapped datapoint in the results database is associated with a reference to the corresponding unmapped datapoint in the database of datapoints.

According to an embodiment, the populate, mapper, and compute modules described herein can function independently of the data platform. The modules can connect to any data source (from any business area), enable creation of mappings, compute newly mapped results, and store results and lookup into a target data store.

According to an embodiment of the system, at least some of the mapping input is generated and trained by NLP/AI/ML methods like entity recognition, LLM, and knowledge graph & retrieval augmented generative approaches. For example, through learnings from the process of data analysis and reporting and medical literature, entities and relationships can be extracted to create a representation of the data (in one aspect as a knowledge graph). The accuracy of this representation can be assessed to the mapping tables confirmed by the hospital customer end user.

According to an embodiment of the system, the list of one or more datapoints to be mapped is provided to a user via a user interface of the data mapping system, and the mapping input is received from the user via the user interface.

According to an embodiment of the system, each datapoint in the list of one or more datapoints to be mapped is representative of a plurality of datapoints in the database of datapoints.

According to an embodiment of the system, the mapper module is further configured to update the mapping by automatically mapping, based on the mapping input received from the user, one or more new datapoints from the database of datapoints.

According to an embodiment of the system, the mapping is updated in response to a command to update received from the user via the user interface.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. The figures showing features and ways of implementing various embodiments and are not to be construed as being limiting to other possible embodiments falling within the scope of the attached claims. Also, the drawings are not necessarily to scale, emphasis instead generally being placed upon illustrating the principles of the various embodiments.

FIG. 1 is a flowchart of a method for mapping data using semantic mapping by a data mapping system, in accordance with an embodiment.

FIG. 2 is a schematic representation of a data mapping system, in accordance with an embodiment.

FIG. 3 is a flowchart of a method for mapping data using semantic mapping by a data mapping system, in accordance with an embodiment.

FIG. 4 is a flowchart of a method for mapping data using semantic mapping by a data mapping system, in accordance with an embodiment.

FIG. 5 is a flowchart of a method for training a data mapping machine learning algorithm, in accordance with an embodiment.

### DETAILED DESCRIPTION OF EMBODIMENTS

The present disclosure describes various embodiments of a system and method configured to map data by a data mapping system. More generally, Applicant has recognized and appreciated that it would be beneficial to provide a method and system to efficiently map data within a large dataset in a scalable way. A data mapping system generates a list of datapoints to be mapped from a database of datapoints, and receives a mapping input comprising a new mapping of one or more of the datapoints in the list, the mapping comprising a new label for a datapoint. The system then maps, based on the received mapping input, one or more additional datapoints from the database of datapoints. The newly mapped datapoints are then saved in a results database, wherein each mapped datapoint is associated with a reference to the corresponding unmapped datapoint in the database of datapoints.

According to an embodiment, the data mapping system enables a machine learning approach to data mapping. The system enhances data meaning by providing multiple methods to introduce vernacular and contextual meaning into the data flow. According to an embodiment there can be initial manual implementation that enables immediate commercialization and customer use, followed by the introduction or application or one or more automated modules. The initial manual method may also serve as an important training feedback into automated methods, including machine learning. The mappings are serving as annotations to create a ground truth. This system provides transparency into data and co-exists with data transformations into clinical ontologies and industry mapping standards.

Thus, according to an embodiment, the methods and systems described or otherwise envisioned herein make analytics more customizable and implementation personnel are able to handle how customers actually engage with their data. Without the mapping, this hyperlocal usage (more than simply language, country, or time zone) requires a concomitant increase in the effort, time, and resources needed to provide this translation mapping. In contrast, the methods and systems described or otherwise envisioned herein reduces the overall cost of delivery and maintenance by creating a self-service mapping tool such that customers can manage their own mappings.

The embodiments and implementations disclosed or otherwise envisioned herein can be utilized with a wide variety of databases and data types. For example, one application of the embodiments and implementations herein is to improve analysis systems such as, e.g., the Philips® IntelliSpace® line of diagnostic and reporting tools (manufactured by Koninklijke Philips, N.V.), among many other products. However, the disclosure is not limited to these devices or systems, and thus the disclosure and embodiments disclosed herein can encompass any method, device, or system for which data mapping may be utilized.

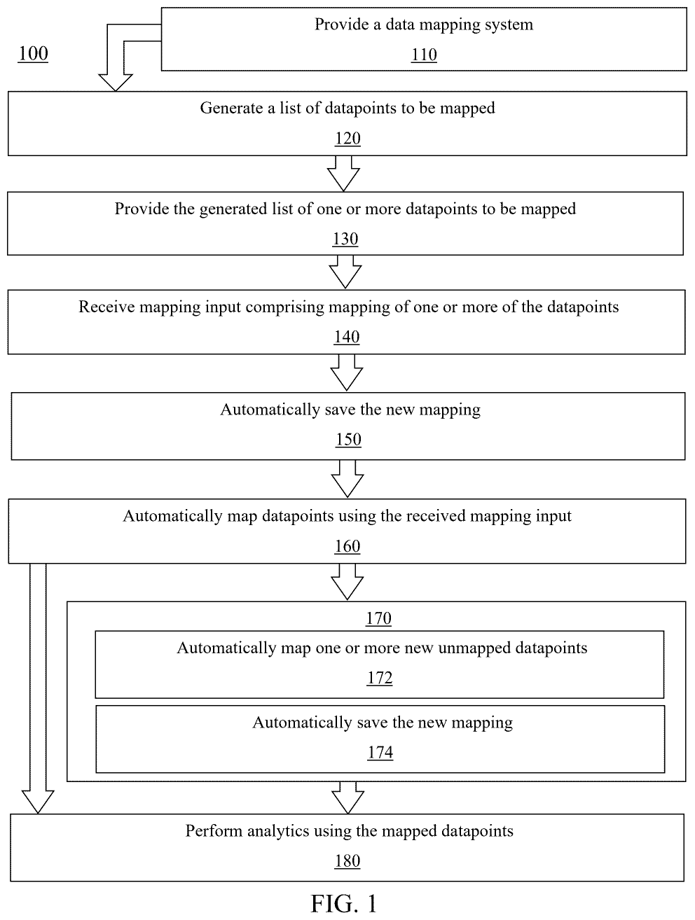

Referring to FIG. 1, in one embodiment, is a flowchart of a method 100 for mapping data using a data mapping system. The methods described in connection with the figures are provided as examples only, and shall be understood not to limit the scope of the disclosure. The data mapping system can be any of the systems described or otherwise envisioned herein. The data mapping system can be a single system or multiple different systems.

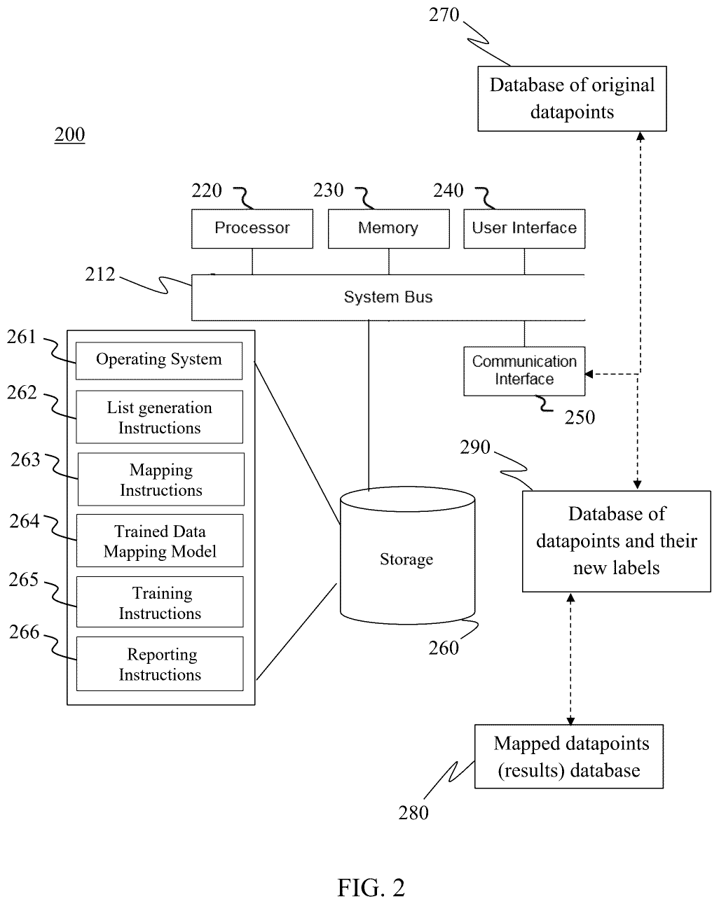

At step 110 of the method, a data mapping system 200 is provided. Referring to an embodiment of a data mapping system 200 as depicted in FIG. 2, for example, the system comprises one or more of a processor 220, memory 230, user interface 240, communications interface 250, and storage 260, interconnected via one or more system buses 212. It will be understood that FIG. 2 constitutes, in some respects, an abstraction and that the actual organization of the components of the system 200 may be different and more complex than illustrated. Additionally, data mapping system 200 can be any of the systems described or otherwise envisioned herein. Other elements and components of the data mapping system 200 are disclosed and/or envisioned elsewhere herein.

According to an embodiment, the data mapping system 200 comprises or is in direct or indirect communication with a database 270 of datapoints. The datapoints, and the associated labeling, can be any data capable of being stored in a database. According to one embodiment, the datapoint labeling may comprise or otherwise be associated with a type of mapping, a data value, and/or many other possible fields. The data mapping system may comprise or may be in direct or indirect communication with the database 270 of datapoints.

Referring to TABLE 1, in one non-limiting embodiment, is a table of datapoints from a database such as an electronic medical record system and/or an electronic medical records (EMR) database from which information about patients, locations, and/or other topics is stored and may be obtained or received. The database can also be part of diagnostic, clinical, and patient management platforms with databases that store similar clinical information. For example, database 270 of datapoints may comprise vital sign data, demographic information, diagnosis information, and/or treatment information about a plurality of patients, and may also comprise information about the locations within an integrated delivery network which may comprise many hospitals and clinics. The datapoints can be stored in one or many tables 272.

TABLE 1
A table of unmapped, original datapoints.

| Study | Study | Study | | Patient | Reason for | |
|---|---|---|---|---|---|---|
| Identifier | Date/Time | Type | FacilityName | Location | study | Conclusions |
| 123- | Jan 1, | Adult | Primary General | Bed 1243 | Pre-surgery | Mitral valve |
| 123456 | 2024, | Echo | Hospital | | | regurgitation |
| | 15:50:34 | | | | | |
| 123- | Feb 1, | 12-Lead | Family Clinic | ECG-01 | Patient | Non-diagnostic; |
| 123457 | 2024, | | | | complained | discharge with |
| | 09:34:02 | | | | of heart | MCOT |
| | | | | | palpitations | recommended |
| 123- | March 1, | Diag/intv | Cardiovascular | CathLab 2 | PCI | |
| 123458 | 2024 | | dept | | | |
| | 14:00:42 | | | | | |

Each of the datapoints in TABLE 1 comprise an example of datapoints from the original clinical database 270. TABLE 1 is an example; the actual clinical platforms can contain many more patient relevant datapoints.

According to an embodiment, the database 270 of datapoints to be labeled may be a local or remote database and is in direct and/or indirect communication with system 200. Thus, according to an embodiment, the system comprises a database 270 of datapoints to be newly labeled.

At step 120 of the method, the system generates a list of one or more datapoints to be mapped. According to an embodiment, the data mapping system generates the list from the database 270 of datapoints, although the source of the databases in the list may be from another database alone or in combination with database 270. According to an embodiment, the datapoints to be mapped are not yet mapped in the database of datapoints. Thus, the generated list 320 of one or more datapoints will enable mapping of those datapoints 270, thereby facilitating downstream analysis.

According to an embodiment, once the list of one or more datapoints 320 to be mapped is generated by the system, it is saved in a datapoints results table. The datapoints results table may be stored within the database 380 of labeled datapoints, or in any other database. The database in which the datapoints results table is stored may be a local or remote database and may be in direct and/or indirect communication with system 200.

According to an embodiment, a fetch module of the data mapping system populates a list with unique terms that can be mapped. An example can be shown using a conventional relational database architecture: the fetch module is code that can access a column, extract values from the column, and then return a “unique” list of values by removing redundant values. The column used for building the unique list can be manually selected (based on expertise of clinical data use from the data store) or by analysis of data column uses by software such as business intelligence or other visualization platforms. The list of datapoints to be mapped with new labels is stored in 320. By default, one or more data columns can be configured to initialize the mapper. For example, as can be seen in TABLE 2, a description of the type of mapping, the data value, and the new label can be basic features in this embodiment. Once saved, the compute module updates a results table as described below. This table is separate from the original data, to maintain data integrity. Calculated results are stored separately.

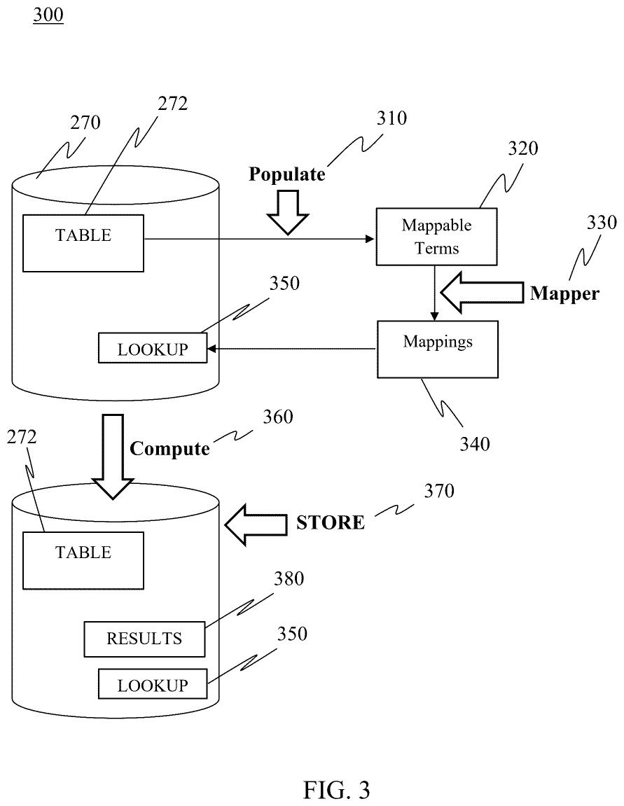

Referring to FIG. 3, in one embodiment, is a method 300 for mapping data by data mapping system 200. This embodiment is shown only as an example and is thus non-limiting. According to this embodiment, the system comprises a database 270 with one or more tables 272 of datapoints, some or none of which may be mapped. A populate module 310 generates the list of one or more datapoints to be mapped, creating the mappable terms list 320. The populate function operates in the background, updating the list as needed. According to an embodiment, previously mapped terms are not touched by the populate function.

According to an embodiment, the system comprises a Mapper module 330 that is utilized to receive and/or manipulate input that provides mapping (i.e., Mappings 340) for one or more of the datapoints to be mapped. The mappings confirmed by the user can be stored in a separate lookup table 350 (also shown as the database of datapoints and their new labels 290 in FIG. 2).

According to an embodiment, the system comprises a Compute module 360 that translates the data as described or otherwise envisioned herein. A Store module 370 stores the results in a Results table 380. The Results table may be stored in database 270 or in any other database. Combining the tables 272 and results 380 will functionalize the real world vernacular descriptions of the original data, thereby enabling downstream analysis.

Referring to TABLE 2, in one non-limiting embodiment, is a selection of the datapoints in 270 to be labeled, given the database shown in TABLE 1, but with a column showing that these datapoints are not yet mapped and/or that the datapoints can be mapped (for the first time or a subsequent time). Thus, the system has generated this list of one or more datapoints to be mapped from the database 270 of labeled datapoints, although the source of the databases in the list may be from another database alone or in combination with database 270.

TABLE 2
A table of unmapped labeled datapoints.

| | | | | |
|---|---|---|---|---|
| | | | | New |
| Data | Field | Group Name | Data | Mapping |

| | | | |
|---|---|---|---|
| Xcelera | StudyType | StudyType | Adult Echo |
| ISECG | FacilityName | RegionCode | Primary |
| | | | General |
| | | | Hospital |
| ISECG | FacilityName | RegionCode | Primary |
| | | | outpatient |
| ISECG | FacilityName | RegionCode | Family clinic |
| ECHO | FindingCode | Clinical statement | FE-0001 |
| ECHO | FindingCode | Clinical statement | FE-0002 |
| ECHO | FindingCode | Clinical statement | FE-0003 |
| ECHO | FindingCode | Clinical statement | FE-0004 |
| ECHO | FindingCode | Clinical statement | FE-0005 |
| ECHO | FindingCode | Clinical statement | FE-0005 |

Once generated, the list of one or more datapoints to be mapped may be utilized immediately and/or may be stored in local and/or remote memory for future use.

At step 130 of the method, the list of one or more datapoints to be mapped, generated in step 120, is provided for use. The list may be provided in any way that enables analysis of a datapoint and enables mapping input to be received for that datapoint. According to an embodiment, the list is provided to a user via a user interface 240 of the data mapping system 200. The user interface can be any device or system that allows information to be conveyed and/or received, and may include a display, a mouse, and/or a keyboard for receiving user commands. The user interface may be located with one or more other components of the system, or may be located remote from the system and in communication via a wired and/or wireless communications network. The list of one or more datapoints to be mapped, displayed or otherwise provided to the user, may be manipulated in a wide variety of ways for, for example, visualization and analysis.

According to another embodiment, as described or otherwise envisioned herein, the list of one or more datapoints to be mapped, generated in step 120, is provided to an automated module or system for mapping. The list may be provided in any way that enables analysis of a datapoint and enables mapping input to be received for that datapoint via the automated module or system. According to an embodiment, the list is provided to a machine learning algorithm that has been trained to receive the list, analyze the list, and provide mapping input. Possible machine learning algorithms, including their input data, training, and output, are described in greater detail herein.

At step 140 of the method, the data mapping system receives a mapping input comprising a new mapping of one or more of the datapoints, the mapping comprising a new label for a datapoint. For example, referring to TABLE 3 in one non-limiting embodiment, is the same table of labeled datapoints from the database shown in TABLE 2, but now the New Mapping column has received a mapping input (i.e., “2D-Echo”).

TABLE 3
A table of unmapped labeled datapoints with new mapping.

| | | | | New |
|---|---|---|---|---|
| Data | Field | Group Name | Data | Mapping |
| Xcelera | StudyType | StudyType | Adult | 2D-Echo |
| ISECG | FacilityName | RegionCode | Primary | |
| | | | General | |
| | | | Hospital | |
| ISECG | FacilityName | RegionCode | Primary | |
| | | | outpatient | |
| ISECG | FacilityName | RegionCode | Family clinic | |
| ECHO | FindingCode | Clinical statement | FE-0001 | |
| ECHO | FindingCode | Clinical statement | FE-0002 | |
| ECHO | FindingCode | Clinical statement | FE-0003 | |
| ECHO | FindingCode | Clinical statement | FE-0004 | |
| ECHO | FindingCode | Clinical statement | FE-0005 | |
| ECHO | FindingCode | Clinical statement | FE-0005 | |

The mapping input can stop there or can continue. For example, referring to TABLE 4 in one non-limiting embodiment, is the same table of labeled datapoints from the database shown in TABLES 1-3, but now the New Mapping column has received a mapping input for each of the presented datapoints.

TABLE 4
A table of unmapped labeled datapoints with new mapping.

| | | | | New |
|---|---|---|---|---|
| Data | Field | Group Name | Data | Mapping |
| Xcelera | StudyType | StudyType | Adult | 2D-Echo |
| ISECG | FacilityName | RegionCode | Primary | Upstate |
| | | | General | |
| | | | Hospital | |
| ISECG | FacilityName | RegionCode | Primary | Upstate |
| | | | outpatient | |
| ISECG | FacilityName | RegionCode | Family clinic | Midlands |
| ECHO | FindingCode | Clinical statement | FE-0001 | Fetal |
| ECHO | FindingCode | Clinical statement | FE-0002 | Fetal |
| ECHO | FindingCode | Clinical statement | FE-0003 | Fetal |
| ECHO | FindingCode | Clinical statement | FE-0004 | Fetal |
| ECHO | FindingCode | Clinical statement | FE-0005 | Fetal |
| ECHO | FindingCode | Clinical statement | FE-0005 | Other |
| | | | | program |

The mapping input can be received from a user via a user interface 240 of the data mapping system 200. As described above, the user interface can be any device or system that allows information to be conveyed and/or received. The provided list of one or more datapoints to be mapped, which is displayed or otherwise provided to the user, may be manipulated in a wide variety of ways to facilitate mapping input. For example, the user interface may comprise mapping entry fields, pulldown menus, or any other method for receiving input from a user. The user providing the mapping input can be any user capable of and/or authorized to provide mapping input.

According to another embodiment, as described or otherwise envisioned herein, the list of one or more datapoints to be mapped, generated in step 120, is provided to an automated module or system for mapping and this automated module or system provides the mapping input. According to an embodiment, the system comprises a machine learning algorithm that has been trained to receive the list, analyze the list, and provide mapping input. Possible machine learning algorithms, including their input data, training, and output, are described in greater detail herein.

Once received, the mapping input may be utilized immediately and/or may be stored in local and/or remote memory for future use.

At step 150 of the method, the data mapping system automatically maps one or more additional datapoints from the database of labeled datapoints based on the received mapping input. According to an embodiment, the system comprises a Compute module 360 that runs and regenerates the results every time the mapping is updated. In this sense, the mapping that occurs is one example of a “compute” operation in module 360.

According to an embodiment, after the mapping input is provided and/or saved, the Compute module 360 is immediately triggered. After processing, the mappings can be used in analytics. As just one example, a user can map a department name field into “cost-centers” used for inter-department billing. The user can of course organize the departments into other units (by specialty, by inpatient/outpatient setting, by satellite offices, by practice, etc.). According to an embodiment, the grouping is customizable. For example, the system can map the same piece of data into multiple groups, thus achieving versatility in data use.

The mapper design is elaborated herein. Referring to TABLE 4, a more generalized design of the lookup is shown. According to an embodiment, the point of such a table is to store all relevant mappings for a site. The mapping amounts to translating the contents of individual data columns. The results table can expand on the fly.

TABLE 4
A Mapper lookup table.

| | | | | | | New | |
|---|---|---|---|---|---|---|---|
| Data | Table | Field | Target | Group Name | Data | mapping | Active? |
| Xcelera | dbo._Study | Study Type | Operational | StudyType | Adult | 2D-Echo | Y |
| ISECG | dbEMS.dbo.tblProcedure | FacilityName | Operational | RegionCode | Primary | Upstate | Y |
| | | | | | General | | |
| | | | | | Hospital | | |
| ISECG | dbEMS.dbo.tblProcedure | FacilityName | Operational | RegionCode | Primary | Upstate | Y |
| | | | | | Outpatient | | |
| | | | | | Upstate | | |
| ISECG | dbEMS.dbo.tblProcedure | FacilityName: | Operational | RegionCode | Family | Midlands | Y |
| | | | | | Clinic | | |
| | | | | | Midlands | | |
| ECHO | dbo.A_ReportingFindings | FindingCode | Clinical | Clinical | FE-0001 | Fetal | Y |
| | | | Query | statements | | | |
| ECHO | dbo.A_ReportingFindings | FindingCode | Clinical | Clinical | FE-0002 | Fetal | Y |
| | | | Query | statements | | | |
| ECHO | dbo.A_ReportingFindings | FindingCode | Clinical | Clinical | FE-0003 | Fetal | Y |
| | | | Query | statements | | | |
| ECHO | dbo.A_ReportingFindings | FindingCode | Clinical | Clinical | FE-0004 | Fetal | Y |
| | | | Query | statements | | | |
| ECHO | dbo.A ReportingFindings | FindingCode | Clinical | Clinical | FE-0005 | Fetal | Y |
| | | | Query | statements | | | |
| ECHO | dbo.A_ReportingFindings | FindingCode | Clinical | Clinical | FE-0005 | Other | Y |
| | | | Query | statements | | program | |

According to an embodiment, the mapper can work by specifying which data sources are to be mapped (columns A, B, C). Results can be stored for separate uses (Column D). For each use, there are specific refinements of the data (Column E). For example, is the system or user cleaning up location metadata, building a set of clinical findings search, grouping technicians by department, and so on. Finally, the “Populate” function needs to fill the table (Column F) and the user (or an automated algorithm) enters the new label (Column G).

One challenge is that for the system to scale, the results table can expand if the Compute module takes columns D and E and uses them to organize the results. The Compute module thus enables the user to map the data as many times as they desire, to provide the hyperlocalization needed to map the data into multiple hospital workflows.

According to an embodiment, the system comprises a machine learning algorithm or other automated component configured to provide mapping input with or without user-provided mapping input. Table 4, for example, can facilitate this process. The frequency of data pulls can be observed by the table parameters. The “Data” to “New Mapping” provides the basic training for a machine learning engine to autogenerate best mappings, and these mappings will enhance the user experience of the hospital analysts who have to build and maintain the maps. Columns D and E act as meta-data, describing the relationship between the “Data” and “New mapping”. These relationships can be captured using knowledge graphs. The result of the knowledge graph is to help the “Compute” module in resolving ambiguous term use (the difference between “cost center” and a simple department grouping).

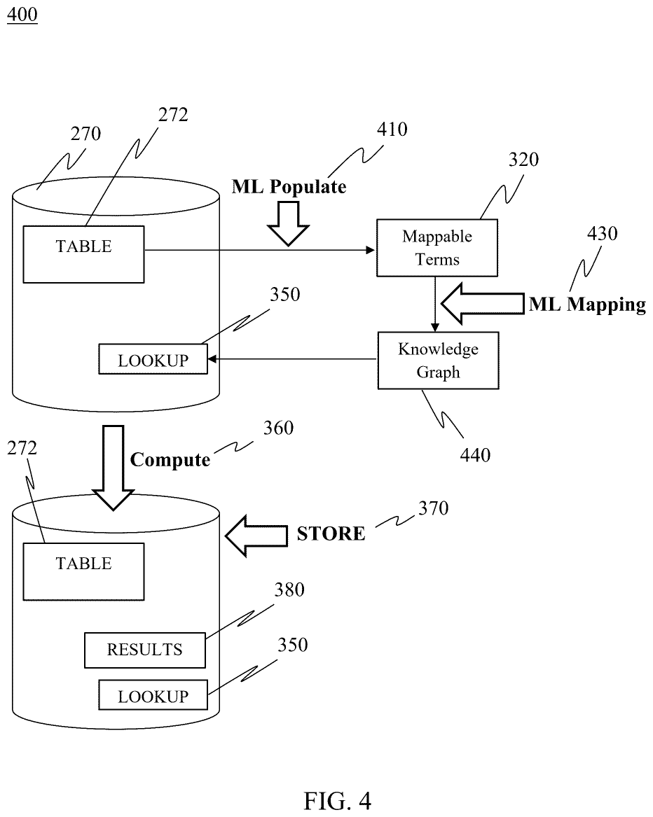

Referring to FIG. 4, in one embodiment, is a method 400 for mapping data by data mapping system 200. This embodiment is shown only as an example and is thus non-limiting. According to this embodiment, at least some of the steps of the method are performed by a trained machine learning algorithm. Referring to FIG. 4, the system comprises a database 270 with one or more tables 272 of datapoints, some or none of which may be mapped. A trained machine learning algorithm such as ML Populate 410 generates the list of one or more datapoints to be mapped, creating the mappable terms list 320. The populate function can operate in the background, updating the list as needed. According to an embodiment, previously mapped terms are not touched by the populate function.

According to an embodiment, the system comprises a trained machine learning algorithm such as ML Mapping 430 that is utilized to provide mapping input with or without user-provided mapping input. The data from TABLE 4, above, provides one method for this process. The relationships shown in TABLE 4 can be captured using knowledge graphs 440. According to an embodiment, the knowledge graph is a way to store relationships between data, forming a set of attributes that describe data fields. Traditionally, the relationships for the knowledge graph are defined by and depend on proper use of the data fields. For example, a “study location” might be designed to reflect the department name. So the knowledge can model that a “study” has a “modality” and is performed at a “study location” on a “patient”. And it is expected that the data elements for each field are entered correctly. However, systems are deployed by the customer to support their workflow, and “study location” can mean room/lab location, department, hospital, clinic, bed number, and so on. The knowledge graph can be extended to capture not only the relationship of the data field, but for the data elements themselves. A knowledge graph can be generated using the data fields, the mapping table, or both. In turn, this knowledge graph can be used as the data model and schema for the data, and the mapping table becomes an interface into the knowledge graph. The knowledge graph can be created manually, using expert knowledge in conjunction with the mapping table and graph database languages. These knowledge graphs can be generated in supervised and unsupervised methods using NLP methods to extract entities and relationships and by graph neural networks. The mappings confirmed by the end hospital user can be stored in a separate lookup table 350 (also shown as the list (database) of datapoints and their new labels 290 in FIG. 2).

According to an embodiment, the system comprises a Compute module 360 that translates the data as described or otherwise envisioned herein. A Store module 370 stores the results in a Results table 380. The Results table may be stored in database 270 or in any other database. A joining of the tables (the original Table 1 with the results in Table 5) will functionalize the real world vernacular descriptions of the original data, thereby enabling downstream analysis.

TABLE 5
An example of a results table, with new labels.

| Study Identifier | Study type | Region | Clinical Program |
|---|---|---|---|
| 123-123456 | Adult | Upstate | Ejection fraction (Simpson's) |
| 123-123457 | Unmapped | Midlands | Myocardial Infarct |
| 123-123458 | Cath | Upstate | Unmapped |

The ML Populate 410 algorithm and the ML Mapping 430 algorithm may be the same or different trained machine learning algorithms. The training of one or more algorithms is fundamentally the same. The trained data mapping machine learning algorithm can be any model that can be trained to utilize the input to generate the output, as described or otherwise envisioned herein. For example, the data mapping machine learning algorithm can be a neural network or other supervised/unsupervised machine learning model. Thus, according to an embodiment, the data mapping system 200 comprises a trained data mapping machine learning algorithm that receives the input data and outputs mapping input and/or automatic mapping of additional datapoints.

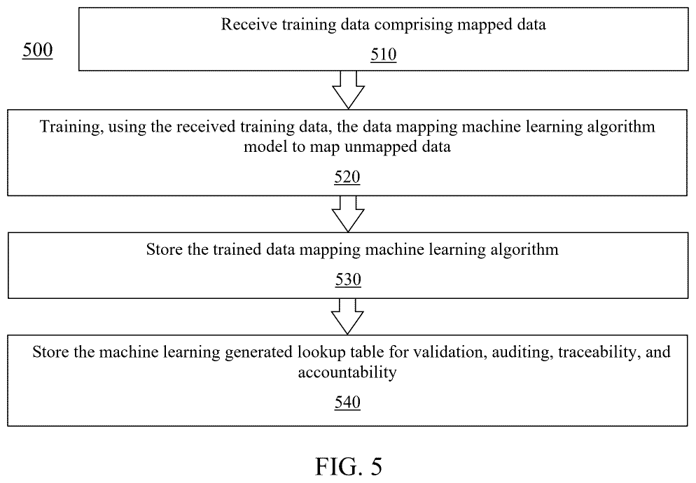

The data mapping machine learning algorithm can be trained in a variety of different ways. According to one embodiment, the data mapping machine learning algorithm is trained in a supervised or unsupervised manner, among other possible training methods. Referring to FIG. 5, in one embodiment, is a flowchart of a method 500 for training the data mapping machine learning algorithm of the data mapping system 200. This method may be performed by the data mapping system, and/or may be performed by another system such as a specialized machine learning model training system.

At step 510 of the method, the training system receives training data which will be used to train the model. The training data can be any data sufficient to train the model to utilize the described input data to generate the described output. For example, the training data may comprise previously mapped data, which thus may include ground truth optimization, from across multiple customers. Other sources include having an LLM to knowledge graph system that is fine-tuned on medical literature, for extracting entities and concepts and building a knowledge graph schema. The training data may also be synthesized, simulated, and created using expert knowledge and curation, as well as technical knowledge on data structures, and may comprise other information. This training data may be obtained and curated by an expert, or it may be obtained and curated under the supervision of an expert, or it may be obtained and utilized without curation. The training data may be received from any source. For example, the training data may be received from tables 272, 380, and 350 of labeled datapoints, or any other component of the system or a training system. According to an embodiment, system 200 comprises or is in direct or indirect communication with a database which comprises some or all of the training data set.

According to an embodiment, the training system may comprise a data pre-processor or similar component or algorithm configured to process the received training data. For example, the data pre-processor analyzes the training data to remove noise, bias, errors, and other potential issues. The data pre-processor may also analyze the input data to remove low quality data. Many other forms of data pre-processing or data point identification and/or extraction are possible.

At step 520 of the method, the training system trains the data mapping machine learning algorithm, to analyze datapoints to identify unmapped datapoints, and/or to generate and provide mapping input for a list of unmapped datapoints. The data mapping machine learning algorithm is trained using any method for training such a model. The trained data mapping machine learning algorithm is a unique model based on the training data used to train the model. Following training, the system comprises a trained data mapping machine learning algorithm.

At step 530 of the method, the trained data mapping machine learning algorithm is stored for future use. According to an embodiment, the trained data mapping machine learning algorithm may be stored in local or remote storage.

At step 540 of the method, a lookup table created by applying the machine learning algorithm to create the list of new mappings from existing datapoints is generated and stored for future use. According to an embodiment, the trained data mapping lookup table may be stored in local or remote storage.

Returning to method 100 depicted in FIG. 1, at step 160 of the method the system automatically saves the new mapping of one or more of the datapoints from database 270 into table 350. The new results database may be a portion of the database 270 of datapoints, or any other database of the system or other system. According to an embodiment, each mapped datapoint in the results database is associated with a reference to the corresponding unmapped datapoint in the database 270 of datapoints. According to an embodiment, non-clinically relevant mappings (location, personnel, cost-centers, etc.) are separated from clinically relevant mappings (e.g., findings, statements, notes, measurements, etc.). According to an embodiment, the compute module function to map clinical and non-clinical data remains the same

At optional step 170 of the method, the mapping is updated with newly generated, newly received, newly saved, or newly identified datapoints. Updating could comprise, for example, automatically mapping 172, by the data mapping system based on the mapping input received from the user in lookup database 350, one or more new datapoints from the database of labeled datapoints 270, and automatically saving 174 the mapping of the one or more new datapoints from the database of labeled datapoints in a results database 280. According to an embodiment, the mapping may be updated in response to a command to update received from the user via the user interface.

There are several benefits of this organizational approach. First, by creating a new results database rather than storing the datapoints in the original database, the original unmapped datapoints and the new mapping of these datapoints is preserved. Thus, the original data can be analyzed if so desired or necessary.

At optional step 180 of the method, the mapped datapoints in the results database are utilized for analytics. This is facilitated by the mapping of the datapoints, as according to an embodiment the mapping was performed to label the datapoints in a way that made sense for the subsequent analysis. Examples of possible analysis are provided or otherwise envisioned herein.

Referring to FIG. 2 is a schematic representation of a data mapping system 200. System 200 may be any of the systems described or otherwise envisioned herein, and may comprise any of the components described or otherwise envisioned herein. It will be understood that FIG. 2 constitutes, in some respects, an abstraction and that the actual organization of the components of the system 200 may be different and more complex than illustrated.

According to an embodiment, system 200 comprises a processor 220 capable of executing instructions stored in memory 230 or storage 260 or otherwise processing data to, for example, perform one or more steps of the method. Processor 220 may be formed of one or multiple modules. Processor 220 may take any suitable form, including but not limited to a central processing unit (CPU), graphical processing unit (GPU), tensor processing unit (TPU), neural processing unit (NPU), microprocessor, microcontroller, multiple microcontrollers, circuitry, field programmable gate array (FPGA), application-specific integrated circuit (ASIC), a single processor, or plural processors.

Memory 230 can take any suitable form, including a non-volatile memory and/or RAM. The memory 230 may include various memories such as, for example L1, L2, or L3 cache or system memory. As such, the memory 230 may include static random access memory (SRAM), dynamic RAM (DRAM), flash memory, read only memory (ROM), or other similar memory devices. The memory can store, among other things, an operating system. The RAM is used by the processor for the temporary storage of data. According to an embodiment, an operating system may contain code which, when executed by the processor, controls operation of one or more components of system 200. It will be apparent that, in embodiments where the processor implements one or more of the functions described herein in hardware, the software described as corresponding to such functionality in other embodiments may be omitted.

User interface 240 may include one or more devices for enabling communication with a user. The user interface can be any device or system that allows information to be conveyed and/or received, and may include a display, a mouse, and/or a keyboard for receiving user commands. In some embodiments, user interface 240 may include a command line interface or graphical user interface that may be presented to a remote terminal via communication interface 250. The user interface may be located with one or more other components of the system, or may be located remote from the system and in communication via a wired and/or wireless communications network.

Communication interface 250 may include one or more devices for enabling communication with other hardware devices. For example, communication interface 250 may include a network interface card (NIC) configured to communicate according to the Ethernet protocol. Additionally, communication interface 250 may implement a TCP/IP stack for communication according to the TCP/IP protocols. Various alternative or additional hardware or configurations for communication interface 250 will be apparent.

Storage 260 may include one or more machine-readable storage media such as read-only memory (ROM), random-access memory (RAM), magnetic disk storage media, optical storage media, hard disk drive (HDD), solid state drive (SSD), flash-memory devices, or similar storage media. In various embodiments, storage 260 may store instructions for execution by processor 220 or data upon which processor 220 may operate. For example, storage 260 may store an operating system 261 for controlling various operations of system 200.

It will be apparent that various information described as stored in storage 260 may be additionally or alternatively stored in memory 230. In this respect, memory 230 may also be considered to constitute a storage device and storage 260 may be considered a memory. Various other arrangements will be apparent. Further, memory 230 and storage 260 may both be considered to be non-transitory machine-readable media. As used herein, the term non-transitory will be understood to exclude transitory signals but to include all forms of storage, including both volatile and non-volatile memories.

While system 200 is shown as including one of each described component, the various components may be duplicated in various embodiments. For example, processor 220 may include multiple microprocessors that are configured to independently execute the methods described herein or are configured to perform steps or subroutines of the methods described herein such that the multiple processors cooperate to achieve the functionality described herein. Further, where one or more components of system 200 is implemented in a cloud computing system, the various hardware components may belong to separate physical systems. For example, processor 220 may include a first processor in a first server and a second processor in a second server. Many other variations and configurations are possible.

According to an embodiment, system 200 comprises or is in direct or indirect communication with a database 270 of datapoints. The datapoints can be any data capable of being stored in a database. According to one embodiment, the datapoint labeling may comprise or otherwise be associated with a type of mapping, a data value, and/or many other possible fields. According to an embodiment, the database 270 may be a local or remote database and is in direct and/or indirect communication with system 200. Thus, according to an embodiment, the system comprises database 270.

According to an embodiment, system 200 comprises or is in direct or indirect communication with a results database 280. According to an embodiment, the database 280 may be a local or remote database and is in direct and/or indirect communication with system 200. Thus, according to an embodiment, the system comprises database 280.

According to an embodiment, system 200 comprises or is in direct or indirect communication with a source data store 270 results data store 280, wherein both stores reside within a separate software application. According to the embodiment, system 200 can operate independently of the software application and can access and write results to the application, in a manner such that the application can access the mapped results.

According to an embodiment, storage 260 of system 200 may store one or more algorithms, modules, and/or instructions to carry out one or more functions or steps of the methods described or otherwise envisioned herein. For example, storage 260 may comprise, among other instructions or data, list generation instructions 262, mapping instructions 263, a trained data mapping machine learning algorithm 264, training instructions 265, and/or reporting instructions 266.

According to an embodiment, list generation instructions 262 direct the data mapping system to generate a list of one or more datapoints to be mapped. According to an embodiment, the data mapping system generates the list from the database 270 of datapoints, although the source of the databases in the list may be from another database alone or in combination with database 270. According to an embodiment, list generation instructions 262 direct the data mapping system to save the list of one or more datapoints to be mapped in a datapoints results table. The datapoints results table may be stored within the database 270 of datapoints, or in any other database. The database in which the datapoints results table is stored may be a local or remote database and may be in direct and/or indirect communication with system 200.

According to an embodiment, mapping instructions 263 direct the data mapping system to automatically map one or more additional datapoints from the database of labeled datapoints based on the received mapping input. According to an embodiment, the system comprises a Compute module 360 that runs and regenerates the results every time the mapping is updated. According to an embodiment, the system comprises a trained machine learning algorithm that performs the mapping.

According to an embodiment, trained data mapping machine learning algorithm 264 is utilized to generate the list of one or more datapoints to be mapped, and/or to provide mapping input, among other possible functions. The trained data mapping machine learning algorithm can be any model that can be trained to utilize the input to generate the output, as described or otherwise envisioned herein. For example, the data mapping machine learning algorithm can be a neural network or other trained machine learning model. Thus, according to an embodiment, the data mapping system 200 comprises a trained data mapping machine learning algorithm that receives the input data and outputs mapping input and/or automatic mapping of additional datapoints.

According to an embodiment, training instructions 265 direct the data mapping system or another system to train a data mapping machine learning algorithm of the data mapping system 200. The instructions direct the system to retrieve, obtain, or receive training data. The training data can be any data sufficient to train the model to utilize the described input data to generate the described output. For example, the training data may comprise previously mapped data. The training instructions 265 further direct the system to train the data mapping machine learning algorithm using the obtained training data. The data mapping machine learning algorithm can be trained using a variety of different training methods. The training instructions 263 further direct the system to store the trained data mapping machine learning algorithm for future use.

According to an embodiment, the data mapping system 200 is configured to process many thousands or millions of datapoints in the input data used to train the data mapping machine learning algorithm, such as via the training instructions. For example, generating a functional and skilled trained data mapping machine learning algorithm from a corpus of training data requires processing of millions of datapoints from input data and generated features. This can require millions or billions of calculations to generate a novel trained data mapping machine learning algorithm from those millions of datapoints and millions or billions of calculations. As a result, each trained data mapping machine learning algorithm is novel and distinct based on the input data and parameters of the model, and thus improves the functioning of the system. Generating a functional and skilled trained data mapping machine learning algorithm comprises a process with a volume of calculation and analysis that a human brain cannot accomplish in a lifetime, or multiple lifetimes.

According to an embodiment, reporting instructions 266 direct the data mapping system to provide output information to a user. The output information may be, for example, the list of one or more datapoints to be mapped, the automatically mapped datapoints, the results of analytics, and/or any other output of the system. The system may provide the information to a user via any mechanism, including but not limited to a visual display, an audible notification, a page, or any other method of notification. The information may be communicated by wired and/or wireless communication to another device. For example, the system may communicate the information to a monitor, screen, mobile phone, computer, laptop, wearable device, and/or any other device configured to allow display and/or other communication of the information.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. A method for mapping data using semantic mapping by a data mapping system, comprising:
generating, by the data mapping system from a database of datapoints, a list of one or more datapoints to be mapped, wherein the list of one or more datapoints is saved in a datapoints results table, and wherein the datapoints to be mapped are not yet mapped in the database of labeled datapoints;
providing the list of one or more datapoints to be mapped;
receiving a mapping input comprising a new mapping of one or more of the datapoints, the mapping comprising a new label for a datapoint;
automatically mapping, by the data mapping system based on the received mapping input, one or more additional datapoints from the database of datapoints; and
automatically saving the new mapping of one or more of the datapoints and the mapped one or more additional datapoints from the database of datapoints in a results database, wherein each mapped datapoint in the results database is associated with a reference to the corresponding unmapped datapoint in the database of datapoints.

2. The method of claim 1, wherein at least some of the mapping input is generated by a trained data mapping machine learning algorithm.

3. The method of claim 1, wherein the list of one or more datapoints to be mapped is provided to a user via a user interface of the data mapping system, and wherein the mapping input is received from the user via the user interface.

4. The method of claim 1, wherein the list of one or more datapoints to be mapped each comprises a type of mapping and a data value.

5. The method of claim 1, wherein the list of one or more datapoints to be mapped is generated by a fetch module of the data mapping system.

6. The method of claim 1, wherein each datapoint in the list of one or more datapoints to be mapped is representative of a plurality of datapoints in the database of datapoints.

7. The method of claim 1, further comprising the step of updating the mapping, comprising the steps of:
automatically mapping, by the data mapping system based on the mapping input received from the user, one or more new datapoints from the database of datapoints; and
automatically saving the mapping of the one or more new datapoints from the database of datapoints in a results database.

8. The method of claim 7, wherein the mapping is updated in response to a command to update received from the user via the user interface.

9. The method of claim 1, further comprising the step of performing, using the mapped datapoints in the results database, analytics.

10. A system for mapping data using semantic mapping, comprising:
a database of labeled datapoints;
a populate module configured to generate, from the database of datapoints, a list of one or more datapoints to be mapped, wherein the list of one or more datapoints is saved in a datapoints results table, and wherein the datapoints to be mapped are not yet mapped in the database of datapoints;
a mapper module configured to: (i) receive a mapping input comprising a new mapping of one or more of the datapoints, the mapping comprising a new label for a datapoint; and (ii) automatically map, based on the received mapping input, one or more additional datapoints from the database of datapoints; and
a store module configured to automatically save the new mapping of one or more of the datapoints and the mapped one or more additional datapoints from the database of datapoints in a results database, wherein each mapped datapoint in the results database is associated with a reference to the corresponding unmapped datapoint in the database of datapoints.

11. The system of claim 10, wherein at least some of the mapping input is generated by a trained data mapping machine learning algorithm.

12. The system of claim 10, wherein the list of one or more datapoints to be mapped is provided to a user via a user interface of the data mapping system, and wherein the mapping input is received from the user via the user interface.

13. The system of claim 10, wherein each datapoint in the list of one or more datapoints to be mapped is representative of a plurality of datapoints in the database of datapoints.

14. The system of claim 10, wherein the mapper module is further configured to update the mapping by automatically mapping, based on the mapping input received from the user, one or more new datapoints from the database of datapoints.

15. The system of claim 14, wherein the mapping is updated in response to a command to update received from the user via the user interface.
